(19) United States
(12) Patent Application Publication
(10) Pub. No.: US 2014/0236547 A1
(43) Pub. Date: Aug. 21, 2014

(54) PATIENT-SPECIFIC AUTOMATED TUNING OF BOUNDARY CONDITIONS FOR DISTAL VESSEL TREE

(71) Applicant: Siemens Aktiengesellschaft, Munich (DE)

(72) Inventors: Lucian Mihai Itu, Brasov (RO); Puneet Sharma, Monmouth Junction, NJ (US); Ali Kamen, Skillman, NJ (US); Dorin Comaniciu, Princeton Junction, NJ (US)

(73) Assignee: Siemens Aktiengesellschaft, Munich (DE)

(21) Appl. No.: 14/167,120

(22) Filed: Jan. 29, 2014

Related U.S. Application Data
(60) Provisional application No. 61/765,165, filed on Feb. 15, 2013.

(51) Int. Cl. G06F 19/12

(52) U.S. Cl. CPC G06F 19/12
USPC 703/2

(57) ABSTRACT

Boundary conditions for a distal vessel tree are modeled and tuned to a specific patient. Measurements from the patient are used to find reference compliance and resistance for the root of the distal vessel tree model. The reference compliance and resistance are used to tune properties of a structured tree model, such as by iteratively solving for the properties while matching the compliance and resistance of the structured tree model to the patient-specific reference compliance and reference resistance. The tuned structured tree is then used to calculate boundary conditions for computing flow of a scanned vessel of the patient.

### RELATED APPLICATIONS

The present patent document claims the benefit of the filing date under 35 U.S.C. §119(e) of Provisional U.S. Patent Application Ser. No. 61/765,165, filed Feb. 15, 2013, which is hereby incorporated by reference.

### BACKGROUND

The present embodiments relate to computation of blood flow in a vessel of a patient. In particular, the boundary conditions at the outlets of the vessel are tuned to the particular patient for computing the vessel flow.

Several outlet boundary conditions have been proposed for three-dimensional, one-dimensional or multiscale models of a distal vessel tree to an outlet of a vessel for which flow is computed. A simple approach is to impose directly the flow rate or the pressure, but this method depends on the availability of the flow rate or pressure quantities, through measurements, for patient-specific geometries. Further, the pressure boundary condition may lead to physiologically incorrect results for vessel geometries with multiple outlets.

In another approach, a three-element Windkessel model uses an analogy with an electrical circuit. The boundary conditions are resistance and compliance of the distal vessel tree at an outlet. The resistance is modeled as two series resistors, and the compliance is modeled as a capacitance or energy storage. Although the Windkessel boundary condition is composed of only three components (e.g., two resistances and one capacitance), the Windkessel model may be tuned in order to match patient-specific quantities.

Both of these approaches do not model the physiological aspects of the downstream vasculature or distal vessel tree. Especially when the wave propagation aspects are of interest in a computational study, the boundary conditions from these approaches are not able to capture the wave propagation phenomena in the distal part of the circulation (i.e., in the region lumped together into the outlet boundary condition based on the model).

In another approach able to model the wave propagation effects distal to the artificial outlets, a structured tree is used to determine the boundary conditions. The distal vasculature is modeled as a simple geometric structure, obtained with a number of simplifying assumptions. These assumptions allow analytic computation of the impedance of the structured tree, which is then imposed at the outlet of the geometric model as a periodic boundary condition. However, it is much more difficult to tune for patient-specific computations in the structured tree approach.

To obtain desired time-varying flow rate and pressure profiles in the proximal part of the structured tree (i.e., at the outlet), the total resistance, total compliance, wave propagation effect, and wave reflection effect of or in the distal domain may be used as properties of the outlet boundary condition. For the Windkessel boundary conditions, the first two aspects may be tuned through the three parameters, but wave propagation and reflection effects may not be tuned. The structured tree boundary condition naturally models the wave propagation effects, but it is difficult to tune the parameters of the structured tree to obtain certain, apriori specified, values of total resistance and compliance.

### BRIEF SUMMARY

By way of introduction, the preferred embodiments described below include methods, computer readable media and systems for automated tuning of boundary conditions for a distal vessel tree. Measurements from the patient are used to find reference compliance and resistance for the root of the distal vessel tree. The reference compliance and resistance are used to tune properties of a structured tree model, such as by iteratively solving for the properties while matching the compliance and resistance of the structured tree model to the patient-specific reference compliance and reference resistance. The tuned structured tree is then used to calculate boundary conditions for computing flow in a scanned vessel of the patient.

In a first aspect, a method is provided for automated tuning of boundary conditions for a distal vessel tree. Scan data representing a vessel of a patient and one or more outlets of the vessel is acquired. A structured tree model models distal vessel tree structure for each of the one or more outlets. Each of the structured tree models is tuned as a function of a match of one or more characteristics of the patient with one or more characteristics of the structured tree model. One or more boundary conditions for the respective one or more outlets are determined. A blood flow quantity for the vessel of the patient is computed as a function of the boundary conditions and displayed.

In a second aspect, a non-transitory computer readable storage medium has stored therein data representing instructions executable by a programmed processor for automated tuning of boundary conditions for a distal vessel tree. The storage medium includes instructions for generating a structured tree model with compliance and resistance values set to values obtained from a patient, calculating boundary conditions from the structured tree model, the boundary conditions calculated from characteristics of the structured tree model responsive to the compliance and resistance values, and determining a hemodynamic property of a vessel of the patient as a function of the boundary conditions.

In a third aspect, a system is provided for automated tuning of boundary conditions for a distal vessel tree. A scanner is configured to scan a vessel of a patient. A processor is configured to determine boundary condition of the vessel from a structured tree construct, to determine first characteristics of the structured tree construct from a match of one or more second characteristics of the structured tree construct with values specific to the patient, and to determine a flow characteristic of the vessel with the boundary condition.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 illustrates an example scanned vessel with corresponding outlet tree models;

FIG. 2 is a flow chart diagram of one embodiment of a method for automated tuning of boundary conditions for a distal vessel tree;

FIG. 3 is a flow chart diagram of one embodiment of a method for calculating compliance for a structured tree;

FIG. 4 is a flow chart diagram of one embodiment of a method for iteratively solving for properties of a structured tree in patient-specific tuning; and

FIG. 5 is a block diagram of one embodiment of a system for automated tuning of boundary conditions for a distal vessel tree.

### DETAILED DESCRIPTION OF THE DRAWINGS AND PRESENTLY PREFERRED EMBODIMENTS

Patient-specific blood flow computations may be performed from patient data, such as medical imaging data. FIG. 1 shows a vessel 40 with one bifurcation and two outlets 42 represented by patient data. The outlets are artificial terminations of the vessel within or at the edges of the scan region, such as at locations where scan data from the patient is not available. To account for parts of the vessel tree not represented in the patient data, boundary conditions at the terminations (e.g., outlets 42) of the represented vessel 40 are determined from models 44 of the distal vessel trees. The models 44 and corresponding boundary conditions may be tuned for the specific patient automatically for more accurate computation of the flow in the vessel 40.

Structured tree boundary conditions are tuned to achieve desired values of total resistance and compliance. The inverse problem of finding parameter values for the structured tree boundary conditions in order to obtain desired overall properties is formulated as the solution of a system of nonlinear equations. Measured values are matched by the corresponding values of the structured tree model to solve for other properties of the structured tree model.

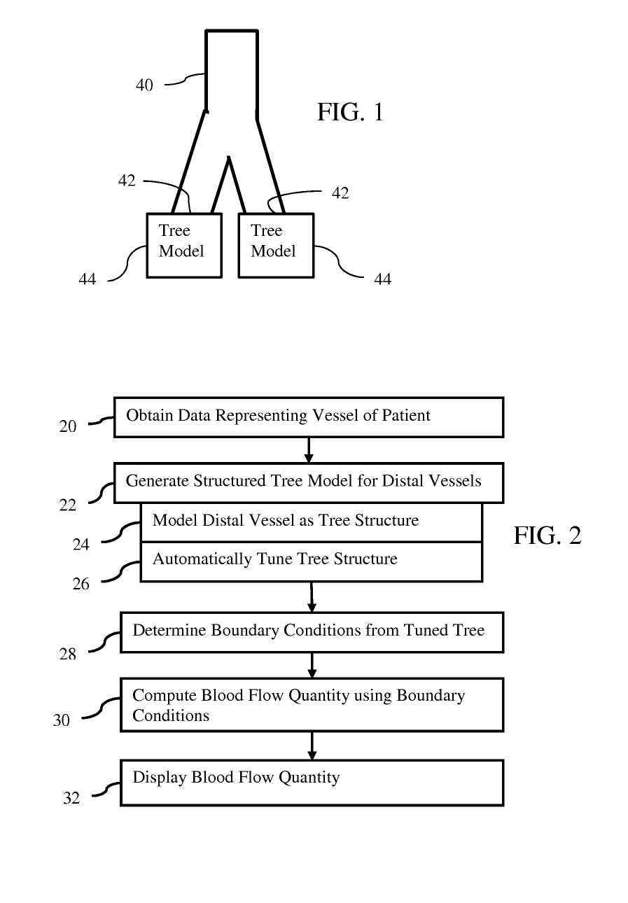

FIG. 2 shows a method for automated tuning of boundary conditions for a distal vessel tree. The method is implemented by a medical diagnostic imaging system, a review station, a workstation, a computer, a picture and archiving and communications system (PACS) station, a server, combinations thereof, or other device for image processing medical diagnostic data. For example, the system, computer readable media, and/or processor shown in FIG. 5 implement the method, but other systems may be used.

The method is implemented in the order shown or a different order. Additional, different, or fewer acts may be performed. For example, acts 30 and/or 32 are not performed. In another example, acts for scanning, storing scanned data, segmenting vessel locations, and/or transfer of results are provided.

The acts are performed in real-time, such as during a surgical procedure. Performing during the procedure allows the clinician to diagnose and/or treat based on flow information computed from the scan data. In other embodiments, the acts are performed after a procedure (e.g., performing as part of a review), as part of diagnosis, or before a procedure for planning. The method may be repeated to provide comparative information over time or to provide flow information for different vessels.

The acts are performed automatically by a processor. The user causes the patient to be scanned or obtains scan data for the patient from a previous scan. The user may activate the process and input patient-specific information, such as the radius of the outflows of the scanned vessel, threshold vessel termination sizes, measures of pressure, and/or measures of flow. Once activated, the method is performed without any user input, such as without user testing of different properties for the structured tree. Alternatively, the user assists in a semi-automated process, such as the user indicating possible values of properties. Other user input may be provided, such as for changing modeling parameter values, correcting output, and/or to confirm accuracy.

In act 20, scan data representing a vessel of a patient and one or more outlets of the vessel is acquired. The data is acquired by scanning the patient. Any type of medical imaging data may be used. For example, computed tomography (CT), C-arm x-ray, standard x-ray, CT-like, magnetic resonance (MR), or ultrasound data is acquired for representing the vessel and outlets. Any scanning sequence or approach may be used.

In an alternative embodiment, the data is acquired by loading from memory. Data from a previously performed scan of the patient is stored in a memory, such as a picture archiving and communications system (PACS) database. The data is selected from the database. The data may be obtained by transfer, such as over a network or on a portable memory device.

The data represents a volume. The data is organized or formatted as a frame, set of data, sets of data, or other collection to represent the volume. The data represents locations distributed in three dimensions. The volume includes one or more vessels 40. A single branch or multiple-branch vessel structure is represented. The vessel 40 may include any number of outlets (e.g., one or more) and extend over any range of the patient's cardiac system or vessel structure.

In one embodiment, the data as acquired is segmented. Using thresholding, edge detection, contrast detection, shape fitting, flow detection, combinations thereof or other process, locations associated with the vessel as compared to other anatomy are identified. The type of scanning or detection may result in acquiring data from the vessel and not other anatomy, such as by contrast detection and/or flow detection. The vessel may be represented as tissue of the vessel walls, the boundary of the vessel tissue with blood, and/or the exterior of the blood column. Alternatively, the acquired data is processed to segment the vessel 40.

In act 22, a structured tree model 42 is generated. In the example of FIG. 2, the processor generates the structured tree model by modeling the distal vessel as a tree structure in act 24 and tuning this tree structure automatically based on information from the specific patient in act 26. Additional, different, or fewer acts may be provided. The acts are performed separately or performed together, such as tuning as part of modeling.

The structured tree model 42 is generated by a processor creating the structured tree and computing characteristics of the structured tree. Alternatively, a plurality of different structured trees associated with different root radii are pre-computed and stored. The structured tree is generated by loading the appropriate pre-determined model given a radius of the patient's vessel. Since the model is to be tuned to the specific patient other than by just the radius of the outlet, a pre-determined structured tree model may be altered by this tuning. Alternatively, the act of computing the structured tree model from scratch also tunes based on the other patient specific information. In yet another embodiment, the pre-determined structured tree models are provided for various combinations of possible patient specific information for identifying and loading the appropriate pre-computed structured tree model for a given outlet of a given patient.

The structured tree model 42 represents the distal vessel tree structure attached the outlet. The geometry and/or blood flow beyond the outlet is modeled. The general shape and material properties of the structured tree effect the blood flow and corresponding boundary conditions at the root of the structured tree model 42. Since patient scan data for this distal tree structure is not available or not used, the distal tree structure and corresponding flow is modeled or simulated using assumptions.

A separate structured tree model is generated for each outlet. Since each outlet is independent or not connected other than by the vessel for which scan data is available, a separate structured tree model is created.

Any structured tree model may be used. Known information may be used to generate the model. For example, larger radius outlets are more likely connected with larger distal tree structures, so the size of the radius of the outlet may be used to model length and number of bifurcations. The root of the structured tree model has the same radius as the outlet for modeled connection with the outlet, but may have a different radius. Bifurcation rather than three-way or more branching may be assumed. The lengths of each branch before the next bifurcation may be based on the radius attributed to that branch. For a bifurcation, each distal branch may be assumed to have a smaller radius. The radius reduction may be scaled between the branches, such as one branch being larger than another. Each branch is scaled by factors that are unequal, creating an asymmetric binary tree with each branch reduced in radius from the proximal branch. Alternatively, both branches radii are the same but reduced by a factor. The factor of radius reduction may be experimentally determined or assumed.

The model represents the entire distal tree structure or only a portion. For example, a radius threshold (e.g., 0.05 μm) is applied. For any branches with a radius smaller than the threshold, the model terminates. This creates terminal ends with a given radius in the structured tree. Beyond these terminal ends, there is no modeling and boundary conditions at the terminal ends are assumed or solved as part of tuning. In other embodiments, the entire distal tree is modeled for the vessels, terminating at arteries.

In one embodiment of act 24, one of the structured tree models and corresponding boundary conditions disclosed in Olufsen, et al., “Numerical simulation and experimental validation of blood flow in arteries with structured-tree outflow conditions,” Annals of Biomedical Engineering, vol. 28, pp. 1281-1299, 2000 or Cousins, et al., “Boundary Conditions for Hemodynamics: The Structured Tree Revisited,” Journal of Computational Physics, Vol. 231, pp. 6086-6096, 2012 is used.

The structured tree is an asymmetric binary tree, where each vessel is axisymmetric and has a constant radius. A power law is used at the bifurcations in order to describe the radiuses of the two daughter vessels:

rₚ^{ξ}=r_{d1}^{ξ}=r_{d2}^{ξ}, (1)

where the subscripts p, d₁ and d₂ refer to the parent vessel, and the two daughter vessels, respectively. The power law assumes that the energy required for blood flow and to maintain the vasculature is minimal (e.g., for laminar flow ξ=3.0). Other values may be used, such as values based on the parent radius. For example, ξ=3.0 is used for large coronary vessels, and a lower value is used for other vessels. The type of flow for a patient may be determined and a value assigned for the tree or parts of the tree based on the type (e.g., varies in the interval between 2.33 (for turbulent flow) and 3.0 (for laminar flow)). The value may depend on the part of the cardiac system being modeled, such as 2.73 for coronary arteriolar bifurcations.

For the structured tree boundary conditions, the bifurcations are considered to be asymmetric, and hence the radii of the daughter vessels are determined, based on the radius of the parent vessel, by using two parameters:

r_{d1}=αrₚ, r_{d2}=βrₚ, (2)

where are α and β are two scaling parameters between 0 and 1. Other scaling may be used. The scaling parameters are pre-determined or calculated. For calculation, two additional parameters are introduced, namely the area ratio and the asymmetry ratio, respectively, defined as:

$$η = \frac{{r}_{d 1}^{2} + {r}_{d 2}^{2}}{{r}_{p}^{2}} , γ = {( \frac{{r}_{d 2}}{{r}_{d 1}} )}^{2} . \qquad ( 3 )$$

The parameters ξ, η and γ are interdependent through the relationship:

$$η = \frac{1 + γ}{{( 1 + {γ}^{ξ / 2} )}^{2 / ξ}} . \qquad ( 4 )$$

The two scaling parameters may be computed as:

α=(1+γ^{ξ/2})^{1/ξ}, β=α\sqrt{λ}. (5)

Starting from a given root radius (e.g., outlet radius), the structured tree bifurcates until the radius of the vessels becomes smaller than a minimum radius. The length of each vessel branch is expressed in terms of the radius of each vessel. For example, a length-to-radius ratio, Iᵣᵣ, is 50, but other values may be used.

Once the branch structure (i.e., geometry) of the structured tree model is determined, the flow, material, and/or other properties of the tree are modeled. Any modeling of non-geometric characteristics of the structured tree model may be used. In one embodiment, Young's model is used. Young's model includes various material properties. Since the small arteries are composed of the same type of tissue as the large arteries, the relationship employed for the large arteries, based on a best fit to experimental data, may also be used for the wall properties of the structured tree down to the smallest vessels represented in the structured tree. One example representation is given as:

$$\frac{Eh}{{r}_{0}} ( x ) = {k}_{1} \cdot exp ( {k}_{2} \cdot {r}_{0} ( x ) ) + {k}_{3} , \qquad ( 6 )$$

where x is the distance along a branch, r₀ is the radius of the branch, k₁₋₃ are material properties, and E is the Young's modulus and h is thickness of the vessel wall . Table 1 shows example parameter values defining the structure and properties of the structured tree.

TABLE 1
Reference parameter values defining the structure and properties of
the structured tree.

| Parameter | Value |
|---|---|
| γ | 0.4048 |
| ξ | 2.7 |
| η | 1.16 |
| α | 0.9087 |
| β | 0.5782 |
| lᵣᵣ | 50.0 |
| k₁ | 2 · 10⁷ g/(s² · cm) |
| k₂ | −25.53 cm⁻¹ |
| k₃ | 4.65 · 10⁵ g/(s² · cm) |

These values are an example or initial values. For a given patient, the values may be different due to tuning to the patient. One or more of the values may be used as constants not altered by the tuning, such as ξ, γ, η, α, β, Iᵣᵣ, and/or k₂.

The governing equations for the blood flow in the structured tree are derived from the axisymmetric Navier-Stokes equations, but other modeling of the flow may be used. Since the viscous effects are much more important than the inertial effects in the small arteries, the nonlinear inertial terms are neglected. If the flow and pressure are periodic, an analytical solution may be determined in the frequency domain:

$$\begin{matrix}Q ( x , ω ) = a \cdot cos ( ω x \text{/} c ) + b \cdot sin ( ω x \text{/} c ) , & ( 7 ) \\ P ( x , ω ) = i \sqrt{\frac{ρ}{{C}_{A} {A}_{0} ( 1 - {F}_{J} )}} ( - a \cdot sin ( ω x \text{/} c ) + b \cdot sin ( ω x \text{/} c ) ) , & ( 8 )\end{matrix}$$

where Q is the flow, P is the pressure, ρ is the density, c is the wave propagation speed, and Fⱼ depends on the Bessel functions and is computed using the Womersley number. C_{A} is the area compliance and may be determined as:

$${C}_{A} = \frac{1}{{k}_{1} \cdot exp ( {k}_{2} \cdot {r}_{0} ( x ) ) + {k}_{3}} \frac{3 \cdot A}{2} , \qquad ( 9 )$$

where A is the cross-sectional area.

The root impedance of the structured tree is computed recursively using the formula:

$$Z ( 0 , ω ) = \frac{i {g}^{- 1} b sin ( ω L \text{/} c ) + Z ( L , ω ) cos ( ω L \text{/} c )}{cos ( ω L \text{/} c ) + i gZ ( L , ω ) sin ( ω L \text{/} c )} , \qquad ( 10 )$$

where g=cC=\sqrt{CA₀(1−F_{J})/ρ}, Z(0,ω) is the impedance at the inlet of the vessel segment or branch, and Z(L,ω) is the impedance at the outlet of the vessel segment or branch. The root impedance is then applied as an outlet boundary condition, represented as:

P(x,ω)=Z(x,ω)·Q(x,ω). (11)

By applying an inverse Fourier transformation, Z(x,ω) is converted into z(x,t) and equation (11) is rewritten using the convolution theorem as:

$$p ( x , t ) = {\int }_{t - T}^{t} q ( x , τ ) z ( x , t - τ ) d τ , \qquad ( 12 )$$

where T is the period.

In act 26, the material properties, flow characteristics, and/or structure of the structured tree model are tuned to the specific patient. The tuning alters or assigns the value of one or more parameters of the structured tree model, resulting in different boundary conditions. Each of the structured tree models is tuned.

Rather than assigning values at random in an effort to determine appropriate boundary conditions, the structured tree is tuned by matching one or more characteristics of the structure tree model with one or more characteristics of the patient. For example, the structured tree model may be used to calculate the resistance and/or compliance at the root or outlet. Resistance and/or compliance for reference in the matching may be calculated from measures of pressure or flow of the patient. The total resistance and/or total compliance of the structured tree are then matched to the resistance and/or compliance of the patient at the outlet. The matching tunes the structured tree boundary conditions.

Various properties of the structured tree are changed to provide the match. A combination of properties or characteristics of the structured tree model are determined by solving for the match of compliance and/or resistance boundary conditions.

Any tuning may be used, such as tuning adapted for hemodynamic simulations. In one embodiment, the determination of the structured tree parameters is formulated as the solution of a system of nonlinear equations with a root where the computed properties of the structured tree and the reference values match. To determine the values of the residuals of the objective functions: f(xᵢ) for a set of parameter values xᵢ the zero-frequency impedance in equation (10) is computed for the structured tree, and the total compliance is determined. The set of parameter values xᵢ are one or more properties or characteristics that are altered or solved to tune.

The nonlinear system f(xᵢ)=0 is solved using a dogleg trust region method, which is a quasi-Newton method, but other optimizations may be used. The performance of this method for updating the parameters is independent of differences in the realistic parameter and objective function values. Nevertheless, since the absolute values of the total resistance and total compliance usually differ by more than six orders of magnitude, both the parameter and the objective residuals have been scaled using typical values, as is described below.

The nonlinear system of equations may be formulated as:

$$f ( \{ \begin{matrix}{R}_{term} \\ {k}_{3}\end{matrix} \} ) = \{ \begin{matrix}{R}_{comp} - {R}_{ref} \\ {C}_{comp} - {C}_{ref}\end{matrix} \} = \{ \begin{matrix}0 \\ 0\end{matrix} \} , \qquad ( 13 )$$

where Rₜₑᵣₘ is the terminal resistance imposed at each outlet of the structured tree (e.g., the terminal resistance where the smallest branches of the model end due to thresholding), R_{comp} is the computed resistance of the structured tree, R_{ref} is the reference resistance from the patient, C_{comp} is the computed compliance, and C_{ref} is the reference compliance from the patient. In this example, Rₜₑᵣₘ and k₃ are the two properties or characteristics of the structured tree that are changed or solved to provide the match (e.g., difference of zero). Additional, different, or fewer characteristics may be used in the solution.

The reference values (e.g., C_{ref} and R_{ref}) are obtained from the patient. Some aspect of the cardiac system of the patient is measured. For example, a pressure or difference in systolic and diastolic pressure is measured with a cuff or ultrasound. As another example, a volume flow, flow rate, or other aspect of flow is measured with ultrasound. The patient is measured, so different or the same values for the aspect result for any two patients.

The measured pressure, measured flow, or both is used to calculate the reference compliance and/or resistance for the patient. Any now known or later developed estimation of compliance or resistance from measured pressure and/or flow may be used. For example, the pulse-pressure method may be used to estimate the compliance, while the resistance may be estimated from the ratio of the pressure to the flow rate. The pressure and flow rate may be measured invasively or non-invasively, or estimated from physiological models or scaling laws.

To iteratively solve the nonlinear equations for the structured tree model, the total resistance and total compliance of the structured tree are calculated. To determine the material property (e.g., k₃) and terminal resistances (e.g., Rₜₑᵣₘ) of the structured tree model, the combination of values resulting in a match is calculated. This tuning adapts the structured tree to a given patient for then calculating boundary conditions at the outlet (e.g., root or total for the structured tree model).

The total resistance and corresponding tuning of the total resistance is a function of the terminal resistances at terminations of the structured tree. For tuning the total resistance, a resistance at the terminal vessels of the structured tree is assigned. All terminal resistances are considered to be equal, a supposition which is sound, since all terminal vessels have approximately the same radius. In other embodiments, the terminal resistances may vary by termination location. The total resistance of the structured tree is equal to the impedance determined for a zero frequency in equation (10).

Any approach for adapting the total resistance represented by the structure tree may be used. In one approach, the minimum radius at which the structured tree is terminated is modified. The calculated total resistance is used in the matching to the reference value during the iterative solution. Modifying the termination radius may only provide for tuning in a discrete space rather than continuous, making a perfect match to a certain value unlikely. Additionally, if the total resistance is very high, the minimum radius becomes very small leading to a considerable increase of the computational cost required to determine the impedance at the root of the structured tree. For the imposition of resistance at each termination

In another approach, a resistance is imposed at each terminal vessel of the structured tree. A certain total resistance is divided by the number of outlets, and the result is imposed at the terminal sites of the structured tree. This approach may lead to the desired results only if the resistances of the vessels inside the structured tree are negligible compared to the terminal resistances. This assumption only holds for large arteries and not for the small arteries of the structured tree that bifurcate down to the arteriolar level.

Matching may be used to calculate the resistance as another approach. The matching solves for one terminal resistance to be applied to each termination or solves for different terminal resistances to be applied to respective terminations. The iterative solution to provide the desired matching solves for the terminal resistance of the structured tree.

The compliance of the structured tree is determined using any approach. The reference total compliance is matched to the total compliance of the structured tree by tuning one or more material properties, such as k₁ and k₃ of equation (6).

In one approach for computing the compliance of the structured tree, the total compliance, Cₐₙ, is computed analytically by summing up the volume compliances of all vessels in the structured tree. The volume compliance, C_{anb}, of a given branch is determined using the area compliance as follows:

C_{anb}=C_{A}·Iᵣᵣ·r, (14)

where Iᵣᵣ is the length-to-radius ratio introduced in Table 1 and r is the radius of the corresponding vessel. C_{A} is the elasticity of the wall of the vessel, as given in equation (9).

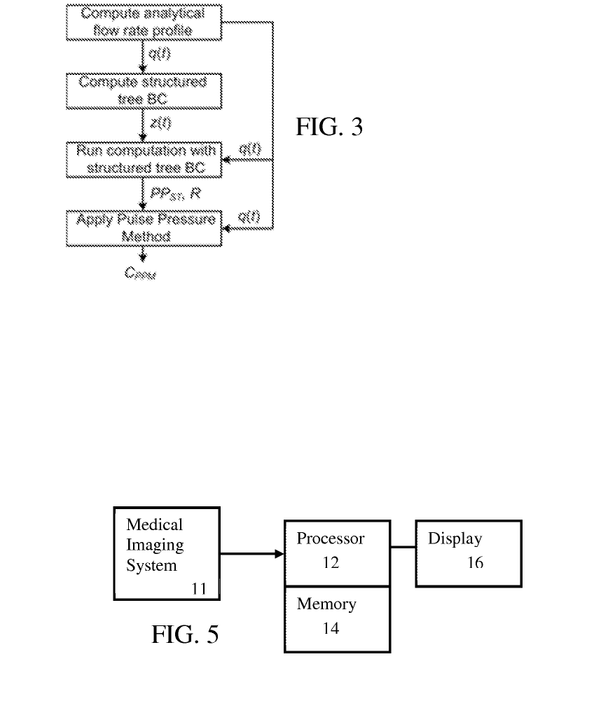

In another approach, a pulse pressure method is used for numerically computing the total compliance of the structured tree. FIG. 3 shows this pulse pressure method-based estimation of total compliance of the structured tree boundary condition. First, an analytical flow rate profile, q(t), is computed using an asymmetric Gaussian function. The average flow rate of the time-varying profile is computed from an average blood flow velocity value of 20 cm/s and the root radius of the structured tree. An empirically determined flow rate profile for a given radius may be used. Alternatively, a measured flow rate is used. Next, the impedance, z(t), of the structured tree boundary condition is determined (see equation (10)). Then, a computation is run by imposing the previously computed flow rate profile at the inlet of the structured tree. As a result, a pressure profile is obtained, which is used to compute the resistance of the structured tree (R= p̅(t)/ q̅(t)) and the pulse pressure, PP_{ST}. Finally, the equivalent compliance, C_{PPM}, of the structured tree is computed using the pulse pressure method. The Pulse Pressure Method estimates the compliance downstream of a location in an arterial tree, based on the time-varying flow rate, the average and the pulse pressure at that location. It is based on the two-element Windkessel model, whereas the resistance of the model is computed directly from the input data and the compliance is the only unknown.

The final compliance value is substantially independent of the chosen average blood flow velocity (e.g., differences are in the order of 10⁻⁸ cm⁴·s²/g), and the numerically computed resistance is substantially equal to the zero-frequency impedance in equation (10) (e.g., differences are in the order of 10⁻⁵ g/(cm⁴·s).

For use in the matching solution, the method displayed in FIG. 3 is applied several times until the tuning procedure for the structured tree boundary condition converges. This aspect and the fact that the pulse pressure method is an iterative process results in application of an efficient search method inside the pulse pressure method for reducing the total execution time. One example search method is the dogleg trust region method. This dogleg trust region method is not only applied for tuning the structured tree parameters, but also for determining the compliance, C_{PPM}, which leads to a reference pulse pressure, PP_{ST}.

The sum of volume compliances is computationally faster than the pulse pressure method. The pulse pressure method may provide more accurate or valid results. Other approaches to calculating the total compliance of the structured tree may be used.

Using the computations for the reference and structured tree compliance and resistance, the nonlinear system of equations may be solved using the matching. The difference between the compliance measured from the patient with the compliance of the structured tree model and the difference between the resistance measured from the patient with the resistance of the structured tree model is minimized. Any optimization may be used, such as the trust region method.

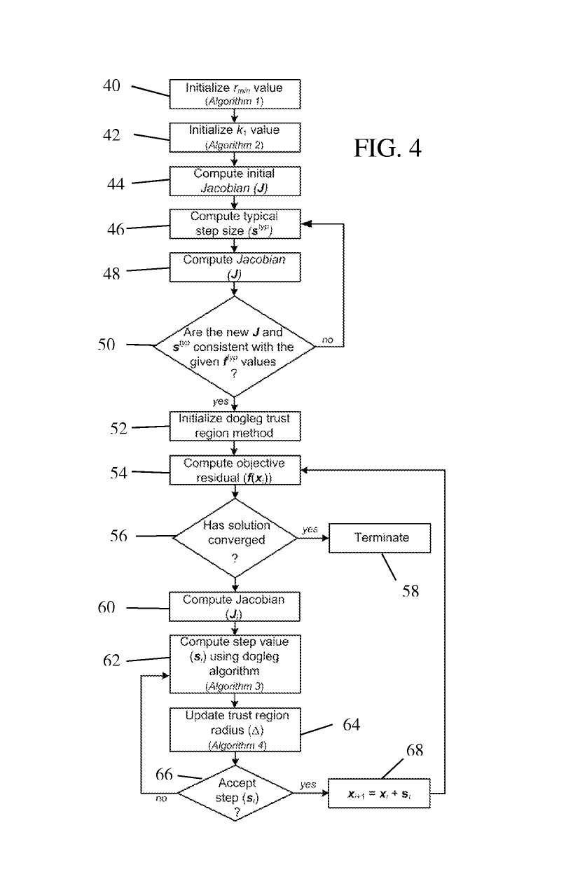

FIG. 4 is a flow chart diagram of one method for tuning. The tuning solves for the properties or characteristics of the structured tree using the matching. Additional, different, or fewer acts may be provided. The acts are performed in the order shown or a different order, such as performing act 42 before act 40.

In the example of FIG. 4, the trust region method is used for optimization. Finding the root of a nonlinear system of equations may be formulated as an optimization application. In order to apply the trust region method, a merit function, which is used to determine how the actual reduction of the residual function behaves in relation to the predicted reduction, is formulated. Any merit function may be used, such as:

$$g ( x ) = \frac{1}{2} {‖ f ( x ) ‖}^{2} , \qquad ( 15 )$$

where the operator ∥·∥ refers to the Euclidian norm. The model function on the other side is based on the Taylor-series expansion of g(x) around the current point xᵢ:

$${m}_{i} ( s ) = \frac{1}{2} {‖ f ( {x}_{i} ) + {J}_{i} s ‖}^{2} = g ( {x}_{i} ) + {s}^{T} {J}_{i}^{T} f ( {x}_{i} ) + \frac{1}{2} {s}^{T} {J}_{i}^{T} {J}_{i} s \qquad ( 16 )$$

where Jᵢ is the Jacobian of f(x) at xᵢ and s is the step taken for the minimization of the merit function. xᵢ is the set of properties or characteristics adapting as part of the tuning, such as k₃ and Rₜₑᵣₘ.

In act 40, a minimum radius for the terminations of the structured tree is initialized before the iterative solution. This initialization ensures that the resistance of the structured tree model is positive for matching with the reference resistance. An example algorithm is provided below for initializing the minimum radius at which the structured tree is terminated.

Algorithm 1. Initialize minimum radius

```
  Set rₘᵢₙ = 0.005 cm
  while(true)
    Compute total resistance (R_{comp}) using rₘᵢₙ and Rₜₑᵣₘ = 0.0
    if R_{comp} < R_{ref}
      break
    else
      rₘᵢₙ = rₘᵢₙ + 0.001
    end(if)
  end(while)
```

Other algorithms may be used.

A starting value of 50 μm is used, which corresponds approximately to the start of the arteriolar level, but other starting values may be used. If the computed total resistance, R_{comp}, obtained with a zero terminal resistance, is lower than the reference value, the algorithm terminates, otherwise the algorithm progressively increases the minimum radius until the computed total resistance becomes lower than the reference value. Algorithm 1 ensures that a positive terminal resistance is required for obtaining the reference resistance.

In act 42, a material property of the structured tree is initialized before the iterative solution. The initialization ensures that the compliance of the structured tree is positive for matching with the reference compliance. An example algorithm is provided below for initializing the material property of the structured tree.

Algorithm 2. Initialize wall properties

```
  Set k1 = 2·10⁷ , k3 = 0
  while(true)
    Compute total compliance (C_{comp})
    if C_{comp} < C_{ref}
      break
    else
      k1 = k1 − 0.1·10⁶
    end(if)
  end(while)
```

In this example, the material property represented by parameter k₁ of the Young's model is initialized. The value displayed in Table 1 is used for the first value of k₁. k₃ is set to O. The total compliance of the structured tree is calculated using these settings or values. A similar approach as in algorithm 1 is used, where the value of k₁ is progressively decreased until the computed compliance becomes lower than the reference compliance.

Using the values of k₁ and the minimum radius, trust region optimization is performed for tuning. The solution for tuning uses a Jacobian matrix and a dogleg trust region in one embodiment, but other solutions for optimization, merit function, and/or step size calculation may be used. In act 44, an initial Jacobian (J) is computed. In act 46, the typical step size value is determined in order to be able to scale both the Jacobian matrix, used for the update of the parameters, and the parameter values (e.g., k₃ and Rₜₑᵣₘ). Some typical values for the objective residuals, f^{typ}, are chosen, and a typical step size for each parameter, sⱼ^{typ}, is determined using the gradient information from a Jacobian estimate:

$${s}_{j}^{typ} = 1 / \sqrt{{\sum }_{i = 1}^{{n}_{eq}} ( {J}_{ij} / {f}_{i}^{typ} )} , \qquad ( 17 )$$

where n_{eq} is the number of equations, in this case two (see equation 13). Initially, the Jacobian J is computed using central difference formulas around the values of Rₜₑᵣₘ=10⁴ g/cm⁴·s and k₃=5·10⁴, or other initial values. The typical values of the objective functions are chosen as 1/50 of the reference values, but other typical value calculations or empirical knowledge may be used.

In act 48, a fixed-point approach is used to find a finite-difference Jacobian, determined using the typical step sizes, which is consistent with the chosen typical values of the objective residuals. The components of the Jacobian approximations are computed as follows:

$${J}_{ij} = \frac{1}{{2}_{j}^{typ}} [ f ( {x}_{0} + \frac{1}{2} {s}_{j}^{typ} {e}_{j} ) - f ( {x}_{0} - \frac{1}{2} {s}_{j}^{typ} {e}_{j} ) ] \cdot {e}_{i} , \qquad ( 18 )$$

where sᵢ^{typ} is computed using equation (17) and eᵢ and eⱼ represent the unit vectors in the ith and jth direction. This is an iterative process which is terminated in act 50 once the Euclidian norm of the difference of two consecutive Jacobians, normalized by the corresponding fᵢ^{typ} and sⱼ^{typ} values, is less than 10⁻⁶ or another value. The typical step size values determined through this iterative process, together with the typical objective residuals, are used in the following acts to normalize the quantities for the dogleg trust region algorithm.

In act 52, the dogleg trust region method is initialized, using the values of Table 2 or other values.

TABLE 2
Constants used for the dogleg trust region algorithm

| Parameter | Value |
|---|---|
| Δ₀ | 1.0 |
| ω_{down} | 0.5 |
| ωᵤₚ | 2.0 |
| ρ₀ | 10⁻⁴ |
| ρ_{low} | 0.25 |
| ρ_{high} | 0.75 |

In act 54, the objective residuals f(xᵢ) are computed inside the trust region algorithm, and the convergence test is performed in act 56. The algorithm terminates in act 58 if each of the residual functions is lower than 1/100 or other factor of the corresponding typical residual value (f₁^{typ}). Otherwise a new Jacobian Jᵢ(xᵢ) is computed in act 60, and the dogleg algorithm is used to determine the next step value sᵢ in act 62. The step sᵢ is computed in act 62 by finding an approximate solution for the subproblem:

$${min}_{s} {m}_{i} ( s ) , subject to ‖ s ‖ \leq Δ$$

where A is the trust region radius.

The dogleg algorithm represents a combination between the Cauchy step (determined along the path of the steepest descent) and the Newton step, given a certain trust region. Thus, the Cauchy point is computed as:

sᵢ^{c}=τ(Δ/∥Jᵢ^{T}f(xᵢ)∥)Jᵢ^{T}f(xᵢ), tm (₁₉)

### Where

τ=min{1, ∥Jᵢ^{T}f(xᵢ)∥³/(Δf(xᵢ)^{T}Jᵢ(Jᵢ^{T}Jᵢ)Jᵢ^{T}f(xᵢ))} (20)

The Newton step is computed using the formula:

sᵢ^{N}=−Jᵢ⁻¹f(xᵢ) (21)

The Newton step is introduced to improve the convergence speed especially in the terminal phase of the search procedure. The power of trust region methods is the ease with which the transition from the steepest descent, with its good global properties, to Newton's method may be managed.

In one embodiment, the dogleg method is implemented as:

Algorithm 3. Dogleg method

```
  Compute sᵢ^{C}
  if ||sᵢ^{C}|| = Δ
    sᵢ = sᵢ^{C}
  else
    Compute sᵢ^{N}
    sᵢ = sᵢ^{C} + τ(sᵢ^{N} − sᵢ^{C}), where τ is the largest value in [0,1] such that
    ||sᵢ|| ≦ Δ
  end(if)
```

Other algorithms may be used to implement the dogleg method.

In act 64, a ratio of actual-to-predicted reduction is computed for each iteration of the trust region. The ratio estimates how well the quadratic model approximates the merit function and is represented as:

$${ρ}_{i} = \frac{{‖ f ( {x}_{i} ) ‖}^{2} - {‖ f ( {x}_{i} + {s}_{i} ) ‖}^{2}}{{‖ f ( {x}_{i} ) ‖}^{2} - {‖ f ( {x}_{i} ) + {J}_{i} {s}_{i} ‖}^{2}} \qquad ( 22 )$$

If the ratio ρᵢ is lower than ρ_{low}, the trust region radius is updated using ω_{down}. If the ratio is higher than ρ_{high}, then the trust region is updated using ωᵤₚ. The step sᵢ is accepted if the ratio is higher than ρ₀.

In one embodiment, the update of the trust region radius is implemented as:

Algorithm 4. Trust region method

```
  Compute sᵢ using dogleg method
  Compute ρᵢ using (22)
  if ρᵢ < ρ_{low}
    Δ = ω_{down}Δ
  else
    if ρᵢ > ρ_{high} and ||ƒ(x)|| = Δ
      Δ = ωᵤₚΔ
    end(if)
  end(if)
  if ρᵢ > ρ₀
    xᵢ₊₁ = xᵢ + sᵢ
  end(if)
```

Other algorithms may be used to implement the update of the trust region radius. This approach incorporates the test of act 66 to re-compute the step value or to update xᵢ₊₁ in act 68 and return to computation of the objective residual in act 54.

Referring to FIG. 2, one or more boundary conditions are determined for each of the outlets from corresponding tuned structured trees. The boundary conditions are calculated from the structured tree model as tuned to a particular patient. Any of the characteristics of the structured tree model may be used. For example, the flow or pressure profile over a heart cycle is determine from equations (7) and (8) using the calculated impedance for the structured tree (see equations (11) and (12)). The values of k₁ and k₃ determined by the solving of the tree structure are used to find the area compliance used in determining these boundary conditions. Other example boundary conditions may be a pressure profile responsive, in part, to the terminal resistances, Rₜₑᵣₘ, solved by creating of the structured tree. Other information may be determined as a boundary condition using the characteristics of the tuned tree structure, such as any of the Young's model or Navier-Stokes equation characteristics. A pressure profile and/or time-varying flow rate may be calculated as the boundary conditions from the material property or properties and terminal resistances solved by tuning to the particular patient.

The characteristics used to find the boundary conditions are responsive to the compliance and resistance. Using patient specific compliance and/or resistance as references during the creation of the structured tree tunes the structured tree to the patient. Any boundary condition may be calculated from the tuned tree for a given outlet.

In act 30, one or more blood flow quantities are computed for the vessel 40. The boundary conditions are used in calculating the quantity. The resistance, compliance, wave propagation, wave reflection, combinations thereof, or other characteristics of the total distal vessel tree for a given outlet may be used to determine the volume flow, pressure, or other quantification of the flow in the vessel. The flow in the vessel is based, in part, on the characteristics of the distal vessel tree, which are accounted for by the boundary conditions. Any hemodynamic property of the vessel of the patient may be determined as a function of the boundary conditions.

In act 32, the blood flow quantity is displayed. An image is presented on a screen or display device with the blood flow quantity. The image is of the quantity. Other information may be presented as well, such as a rendering of the vessel from the scan data, geometric information about the vessel, structured tree properties, boundary conditions, or other information useful for diagnosis of the patient. For example, a three-dimensional rendering from the scan data shows the vessel from a given view. A blood flow quantity, such as flow rate and/or pressure over time, is displayed as a graph, bar chart, or numerical value (e.g., average or variance per cycle) adjacent to or overlaid on the rendering.

A known arterial tree may be used to test the method of FIGS. 2-4 for tuning the total resistance and total compliance of the structured tree boundary condition. Specifically, the total resistance and total compliance values of the outlet boundary conditions in the known arterial tree are used as reference values, and the structured tree boundary condition is tuned separately for each outlet vessel of any of various vessels. The results of the tuning procedure are displayed in Table 3. The minimum radius at which the structured tree terminates is for some arteries higher than 0.005 cm. In those cases, even without terminal resistance, the total initial resistance is higher than the reference value.

The total resistance values given in Table 3 correspond to the rest state. If an exercise state were to be simulated, the total resistances may be smaller and a higher minimum radius may be used. Generally, the terminal resistances imposed at the terminal sites of the structured tree are three-to-five orders of magnitude higher than the total resistance of the structured tree.

Regarding the tuning of the total compliance, the results show that the analytically computed compliance is considerably different from the pulse pressure method-based compliance. The pulse pressure method may be more accurate. Regarding k₁, algorithm 2 changes the value, showing that normally a smaller value of k₁ is required than the initial value displayed in Table 1, for obtaining the reference compliance with a positive value for k₃.

Although the compliance is computed numerically at each tuning iteration, the execution time for the tuning of each structured tree may be less than 10 seconds on a personal computer. The proposed tuning is computationally efficient. Only 3-10 iterations may be required for convergence. The dogleg trust region method is not only applied for the tuning of the structured tree properties but also for the search procedure performed for the pulse pressure method.

The reference resistance and compliance values are physiological, which allow for a successful application of the tuning procedure. Equation (13) may not have a solution if either of the two reference parameters have unrealistic values. For example, if the reference compliance value is too high, a negative value for k₁ may be required, which in turn leads to an instable structured tree impedance.

TABLE 3
Autotuning of the structured tree boundary condition for the outlet vessels of the arterial tree

| | | R_{ref} | | | | Rₜₑᵣₘ | | | |
|---|---|---|---|---|---|---|---|---|---|
| | rᵣₒₒₜ | [10³ g/) | C [10⁻⁶ cm⁴ · s²/g] | | rₘᵢₙ | [10⁶ g/ | k₁ | k₃ | |
| Artery | [cm] | cm⁴ · s)] | PPM | Anal. | [cm] | (cm⁴ · s)] | [g/(s² · cm)] | [g/(s² · cm)] | Nr. iter. |
| Carotid | 0.083 | 139.0 | 0.91 | 3.27 | 0.010 | 1.85 | 1.3 · 10⁶ | 11.83 · 10³ | 4 |
| Interosseus | 0.091 | 84.3 | 0.22 | 0.69 | 0.015 | 91.3 · 10⁻³ | 9.0 · 10⁶ | 81.64 · 10³ | 4 |
| Tibal anterior | 0.13 | 55.9 | 3.33 | 2.90 | 0.007 | 4.746 | 4.0 · 10⁶ | 33.7 · 10³ | 3 |
| Tibal posterior | 0.141 | 47.7 | 3.9 | 3.43 | 0.007 | 12.13 | 6.0 · 10⁶ | 28.34 · 10³ | 4 |
| Radial | 0.142 | 52.8 | 3.52 | 3.12 | 0.005 | 11.26 | 8.0 · 10⁶ | 3.31 · 10³ | 2 |
| Intercostals | 0.150 | 13.9 | 13.38 | 36.4 | 0.038 | 12.6 · 10⁻³ | 2.0 · 10⁶ | 19.37 · 10³ | 4 |
| Inf. Mesenteric | 0.160 | 68.8 | 2.70 | 2.36 | 0.005 | 578.0 | 2.0 · 10⁷ | 72.4 · 10³ | 7 |
| Gastric | 0.180 | 54.1 | 3.44 | 2.91 | 0.005 | 651.6 | 2.0 · 10⁷ | 269.9 · 10³ | 8 |
| Ulner | 0.183 | 60.1 | 3.10 | 2.57 | 0.005 | 867.8 | 2.0 · 10⁷ | 375.0 · 10³ | 8 |
| Vertebral | 0.183 | 52.8 | 3.52 | 2.96 | 0.005 | 659.9 | 2.0 · 10⁷ | 300.5 · 10³ | 7 |
| Femoral | 0.186 | 47.7 | 3.90 | 3.29 | 0.005 | 597.2 | 2.0 · 10⁷ | 287.7 · 10³ | 7 |
| Iliac | 0.200 | 79.4 | 2.34 | 1.78 | 0.005 | 2073 | 2.0 · 10⁷ | 940.5 · 10³ | 10 |
| Hepatic | 0.220 | 36.3 | 5.13 | 4.05 | 0.005 | 846.6 | 2.0 · 10⁷ | 546.5 · 10³ | 9 |
| Renal | 0.260 | 11.3 | 16.46 | 13.35 | 0.005 | 2245 | 2.0 · 10⁷ | 284.0 · 10³ | 8 |
| Splenic | 0.275 | 23.2 | 8.02 | 29.74 | 0.005 | 1141.3 | 2.0 · 10⁷ | 826.5 · 10³ | 9 |
| Sup. | 0.435 | 9.3 | 20.0 | 91.07 | 0.005 | 2018 | 2.0 · 10⁷ | 1605 · 10³ | 10 |
| Mesenteric | | | | | | | | | |

The structured tree boundary conditions are tuned automatically for hemodynamic computations. The parameters of the structured tree boundary condition are tuned to obtain certain reference values for the total resistance and the total compliance. Two parameters are initially adapted, the minimum radius at which the structured tree terminates and the constant k₁, in order to determine a starting point that leads to positive values for the actual tuning parameters. Two parameters are adapted for tuning the two properties of the structured tree: the terminal resistance (equal at all termination sites), and a constant (k₃) which determines the wall properties. Other initial and/or adapting properties may be used.

The tuning is performed using the dogleg trust region method, which is an efficient approach, requiring only 3-10 iterations. Other numbers of interations may occur. One advantage of the proposed method is that no initial search algorithm is required, the initial starting point obtained through algorithms 1 and 2 being a good enough initial solution for the trust region method.

The method may be easily integrated in a higher order tuning algorithm for hemodynamics computations where Windkessel boundary conditions are used to match certain patient-specific hemodynamic properties. Instead of using directly the Windkessel parameter values given by the higher-order tuning algorithm at each iteration, the structured tree boundary conditions are used, and the tuned structured tree is used to prescribe the reference resistance and compliance values. Alternatively, the parameters of the structured tree boundary condition are directly tuned without using the resistances and compliances as intermediate quantities.

FIG. 5 shows a system for automated tuning of boundary conditions for a distal vessel tree. The system includes a medical imaging system 11, a processor 12, a memory 14, and a display 16. The processor 12 and the memory 14 are shown separate from the medical imaging system 11, such associated with being a computer or workstation apart from the medical imaging system 11. In other embodiments, the processor 12 and/or memory 14 are part of the medical imaging system 11. In alternative embodiments, the system is a workstation, computer, or server for tuning boundary conditions and calculating blood flow quantities from data acquired by a separate system in real-time or using previously acquired patient-specific data stored in a memory. For example, the medical imaging system 11 is provided for acquiring data representing a volume, and a separate database, server, workstation, and/or computer is provided for tuning and computing. Additional, different, or fewer components may be used.

The computing components, devices, or machines of the system, such as the medical imaging system 11 and/or the processor 12 are configured by hardware, software, and/or design to perform calculations or other acts. The computing components operate independently or in conjunction with each other to perform any given act, such as the acts of FIGS. 2-4. The act is performed by one of the computer components, another of the computing components, or a combination of the computing components. Other components may be used or controlled by the computing components to scan or perform other functions.

The medical imaging system 11 is any now known or later developed modality for scanning a patient. The medical imaging system 11 scans the patient for a vessel region. For example, a C-arm x-ray system (e.g., DynaCT from Siemens), CT like system, or CT system is used. Other modalities include MR, x-ray, angiography, fluoroscopy, PET, SPECT, or ultrasound. The medical imaging system 11 is configured to acquire the medical imaging data representing one or more vessels. The data is acquired by scanning the patient using transmission by the scanner and/or by receiving signals from the patient. The type or mode of scanning may result in receiving data of just the vessel. Alternatively, data of a volume region is received and the vessel information is segmented from information of other anatomy.

The memory 14 is a buffer, cache, RAM, removable media, hard drive, magnetic, optical, database, or other now known or later developed memory. The memory 14 is a single device or group of two or more devices. The memory 14 is within the system 11, part of a computer with the processor 12, or is outside or remote from other components.

The memory 14 stores the structured tree, characteristics of the structured tree, intermediate solution data, measured characteristics of the patient, the scan data, or other vessel or flow information. The memory 14 stores data resulting from the processes described herein, such as storing the constants, initial values, tuned values, or other properties.

The memory 14 is additionally or alternatively a non-transitory computer readable storage medium with processing instructions. The memory 14 stores data representing instructions executable by the programmed processor 12 for automated tuning of boundary conditions for a distal vessel tree. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The processor 12 is a general processor, digital signal processor, three-dimensional data processor, graphics processing unit, application specific integrated circuit, field programmable gate array, digital circuit, analog circuit, combinations thereof, or other now known or later developed device for processing medical data. The processor 12 is a single device, a plurality of devices, or a network. For more than one device, parallel or sequential division of processing may be used. Different devices making up the processor 12 may perform different functions, such as tuning by one device and computation of boundary conditions and/or flow quantities by another device. In one embodiment, the processor 12 is a control processor or other processor of the medical imaging system 11. The processor 12 operates pursuant to stored instructions to perform various acts described herein.

The processor 12 is configured to determine characteristics of the structured tree construct from a match of one or more other characteristics of the structured tree construct with values specific to the patient. For example, the terminal resistances and a material property of the structured tree construct are determined from a match of the total compliance and total resistance of the structured tree construct with compliance and resistance at an outlet of the vessel for a given patient. The structured tree construct created by the processor 12 represents a vessel tree distal to the vessel for which scan data is acquired and the computation to be performed.

The processor 12 is configured to determine one or more boundary conditions of the vessel from a structured tree construct. The flow characteristics at the outlet of the vessel are the boundary conditions. The structured tree characteristics are used to calculate the boundary conditions. The characteristics themselves may be a boundary condition.

The processor 12 is configured to determine a flow characteristic of the vessel with the boundary condition. Some aspect of the flow in the vessel is determined, using in part, the boundary condition for distal vessels.

The processor 12 is configured to generate an image. The image includes a computed quantity of the flow in the vessel. The image may include a representation of the vessel and/or structured tree model.

The display 16 is a CRT, LCD, plasma, projector, printer, or other output device for showing an image. The display 16 displays the quantity or quantities calculated using the boundary conditions. The quantities may be displayed in a chart, graph, and/or on an image.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method for automated tuning of boundary conditions for a distal vessel tree, the method comprising:
acquiring scan data representing a vessel of a patient and one or more outlets of the vessel;
modeling a distal vessel tree structure;
tuning the modeling as a function of a match with one or more characteristics of the patient;
determining, from the tuning, one or more boundary conditions for the respective one or more outlets based on a relationship between flow and pressure;
computing a blood flow quantity for the vessel of the patient as a function of the boundary conditions; and
displaying the blood flow quantity.

2. The method of claim 1 wherein modeling comprises modeling as a structured tree model, and wherein tuning comprises tuning the structured tree model.

3. The method of claim 1 wherein modeling comprises modeling with scaled radii for bifurcations, lengths of branches between bifurcations being a function of respective radii, and a root radius being based on a radius of the outlet from the scan data.

4. The method of claim 1 wherein the one or more characteristics comprise resistance and compliance, and wherein tuning comprises tuning as the function of the match of the resistance and the compliance measured from the patient with the resistance and the compliance of the modeling.

5. The method of claim 4 wherein the resistance and the compliance measured from the patient comprise measuring a pressure or flow from the patient and computing the resistance and the compliance from the pressure or the flow.

6. The method of claim 4 wherein tuning comprises solving a nonlinear system of equations with the match comprising minimizing a difference between the compliance measured from the patient with the compliance of the modeling and a difference between the resistance measured from the patient with the resistance of the modeling.

7. The method of claim 6 wherein solving comprises performing trust region optimization.

8. The method of claim 4 wherein the resistance of the modeling is set as a function of terminal resistances at terminations of a structured tree, and wherein the tuning comprises initializing minimum radii for the terminations so that the resistance of the structured tree is positive for the match with the resistance from the patient.

9. The method of claim 4 wherein the compliance of the modeling is determined as a function of a pulse pressure method.

10. The method of claim 4 wherein modeling comprises modeling properties with Young's model, including a first material property, and wherein tuning comprises performing the match as a function of the first material property.

11. The method of claim 10 wherein tuning comprises initializing a second material property of the Young's model so that the compliance of the modeling is positive for the match with the compliance from the patient.

12. The method of claim 1 wherein tuning comprises tuning as a function of termination resistances and a material property.

13. The method of claim 1 wherein tuning comprises turning as a function of a Jacobian matrix and a dogleg trust region.

14. The method of claim 1 wherein determining the one or more boundary conditions comprise determining a time-varying flow rate and pressure profile for a first one of the outlets from the modeling as tuned.

15. The method of claim 1 wherein computing the blood flow quantity comprises computing as a function of the boundary conditions comprising a resistance, a compliance, and wave and reflection effects, and wherein displaying comprises displaying an image with the blood flow quantity.

16. In a non-transitory computer readable storage medium having stored therein data representing instructions executable by a programmed processor for automated tuning of boundary conditions for a distal vessel tree, the storage medium comprising instructions for:
generating a structured tree model with compliance and resistance values set to values obtained from a patient;
calculating boundary conditions from the structured tree model, the boundary conditions calculated from characteristics of the structured tree model responsive to the compliance and resistance values; and
determining a hemodynamic property of a vessel of the patient as a function of the boundary conditions.

17. The non-transitory computer readable storage medium of claim 16 wherein generating the structured tree model comprises generating the structured tree model with a root radius set to a vessel radius of the patient and solving for the characteristics of the structured tree model with a match of the compliance and the resistance values to the values obtained from the patient as reference values, the reference values obtained from the patient being a function of a measured pressure, measured flow, or measured pressure and flow from the patient.

18. The non-transitory computer readable storage medium of claim 16 wherein generating comprises iteratively solving nonlinear equations for the structured tree model, the solving providing a material property and terminal resistances of the structured tree model, and wherein calculating the boundary conditions comprises calculating a pressure profile, a time-varying flow rate, or both as a function of the material property and the terminal resistances.

19. A system for automated tuning of boundary conditions for a distal vessel tree, the system comprising:
a scanner configured to scan a vessel of a patient; and
a processor configured to determine boundary condition of the vessel from a structured tree construct, to determine first characteristics of the structured tree construct from a match of one or more second characteristics of the structured tree construct with values specific to the patient, and to determine a flow characteristic of the vessel with the boundary condition.

20. The system of claim 19 wherein the processor is configured to determine the first characteristics as terminal resistances and a material property of the structured tree construct from a match of the second characteristics comprising total compliance and total resistance of the structured tree construct with the values specific to the patient comprising compliance and resistance at an outlet of the vessel, the structured tree construct representing a vessel tree distal to the vessel.
